(19) United States
(12) Patent Application Publication
(10) Pub. No.: US 2009/0133803 A1
(43) Pub. Date: May 28, 2009

(54) Device and Means of Processing a Material by Means of an Ultrasonic Device

(75) Inventor: Marcus Lehto, Goteborg (SE)

Correspondence Address: BUCHANAN, INGERSOLL & ROONEY PC, POST OFFICE BOX 1404, ALEXANDRIA, VA, 22313-1404, US

(73) Assignee: SCA HYGIENE PRODUCTS AB, GOTEBORG (SE)

(21) Appl. No.: 12/159,807

(22) PCT Filed: Feb. 10, 2006
(86) PCT No.: PCT/SE2006/000182

§ 371 Date: Jul. 1, 2008

(51) Int. Cl. B32B 37/00

(52) U.S. Cl. 156/73.1; 156/580.1

(57) ABSTRACT

An arrangement for processing of a material including at least one layer of material by an ultrasonic device having an ultrasound horn arranged adjacent to an abutment, in conjunction with which a gap is defined between the aforementioned ultrasound horn and the aforementioned abutment, in conjunction with which the aforementioned ultrasonic device is arranged for the purpose of feeding the aforementioned material through the aforementioned gap. The arrangement includes a pre-compression unit for the mechanical compression of the aforementioned material before it is fed through the aforementioned gap.

### TECHNICAL FIELD

The present disclosure relates to an arrangement for processing of a material comprising at least one layer of material by an ultrasonic device an ultrasound horn arranged adjacent to an abutment, in conjunction with which a gap is defined between the aforementioned ultrasound horn and the aforementioned abutment, in conjunction with which the aforementioned ultrasonic device is arranged for the purpose of feeding the aforementioned material through the aforementioned gap.

The disclosure also relates to a method for processing of a material comprising at least one layer of material by means of an ultrasonic device comprising an ultrasound horn arranged adjacent to an abutment, in conjunction with which the aforementioned method involves feeding the aforementioned material through a gap that is defined between the aforementioned ultrasound horn and the aforementioned abutment.

### BACKGROUND ART

Ultrasound technology is used in certain processes that are arranged for the processing of continuous webs of material. This technology is already familiar and is suitable, for example, for joining together two or more layers of material of the nonwoven material type or other relatively thin layers of material. In the case of such joining together, which is also known as ultrasonic welding, a laminate is formed from the layers of material concerned. Such laminates are usually encountered in the manufacture of absorbent products such as diapers, incontinence pads, sanitary towels and panty liners.

In addition to the joining together of different materials, ultrasound technology can also be used for other types of processing, for example perforation, cutting, pattern embossing or forming of materials. Examples of materials that are suitable for processing by means of ultrasound technology include nonwoven materials, that is to say fibrous materials, for example with synthetic fibres such as polyethylene, polypropylene, polyester, nylon or the like. Mixtures of different types of fibre can also be used. Ultrasound technology can also be used for the processing of, for example, thermoplastic films of polyethylene or polypropylene.

In the case of processing in the form of the joining together of two materials intended for absorbent products, an ultrasonic device is often used in such a way that the materials are supplied in the form of continuous webs of material or discrete items that are fed past an ultrasound horn belonging to the ultrasonic device and an abutment surface. This abutment surface is appropriately defined by a rotating abutment roller or a plane surface which functions as an abutment. The ultrasound horn is often stationary in this case. The materials are positioned so that they can be fed through a relatively small gap between the ultrasound horn and the abutment roller. In order to achieve the desired joining together of the two webs of material, the ultrasound arrangement is driven according to the prior art at a certain amplitude and with a certain power. Furthermore, the gap between the ultrasound horn and the abutment roller must be appropriately dimensioned.

A side effect of the procedure described above for the ultrasonic processing of material is that friction occurs between the material and the stationary ultrasound horn when the material is fed past the ultrasound horn. More particularly, this situation can arise as a consequence of the fact that the material, which in turn can consist of one or more layers of material, that is fed through the gap in the ultrasonic device is normally thicker than the width of the gap. Furthermore, a certain mechanical compression of the material can occur when it is fed through the gap, that is to say mechanical compression primarily of the material on the side that comes into contact with the ultrasound horn. Energy losses occur in this way as a consequence of this compression while the material is being caused to advance continuously in its longitudinal direction in relation to the stationary ultrasound horn.

Friction thus occurs in this way through the contact between the material and the surface of the ultrasound horn, together with energy losses as a consequence of the mechanical compression of the material. All in all, this leads to a method of ultrasonic processing that is difficult to control, with a relative narrow “process window” within which this can be undertaken in an optimal fashion. This means, for instance, that ultrasonic processing in the form of ultrasonic welding must be controlled in an accurate manner in order to ensure that the welding power is maintained, on the one hand, at a sufficiently high level to obtain correct welds and, on the other hand, at a sufficiently low level to prevent the material from being damaged. Accordingly, because of the above-mentioned effects that are difficult to control, a relatively narrow interval is obtained in respect of the process parameters with the help of which the ultrasonic processing must be controlled.

The above-mentioned sequence involving friction between the material and the ultrasound horn and mechanical compression of the material becomes more noticeable in proportion to the speed at which the process takes place. At relatively high process speeds, the effects of friction and mechanical compression are relatively high and can result in the formation of holes in the actual material if the supplied power is excessively high. One natural means of counteracting this problem is to increase the gap between the ultrasound horn and the abutment roller, whereby the supplied energy from the ultrasonic device is reduced. One consequence of this, however, is that a reduction in the above-mentioned effects is also achieved in this way in the form of friction and mechanical compression of the material that is to be processed. This can mean that the energy supplied to the material can fall drastically, which can lead in turn to a situation with excessively low lamination strength and incomplete ultrasonic welding. This problem is particularly evident at relatively high process speeds and with relatively thick materials or material combinations.

One way of explaining the above-mentioned phenomena is to take as one's starting point the prior art, according to which it can normally be expected that the welding power in an ultrasonic device must be increased essentially in proportion to the process speed, which then corresponds to a linear relationship between the welding power and the process speed. It is nevertheless possible in certain cases to establish the existence of a deviation from this linear sequence; the welding power cannot then be increased as anticipated as the process speed increases. The fact is that a low welding power in relative terms may be required instead as the process speed rises above a certain limit. This deviation between the actual welding power and the theoretically anticipated welding power can be explained by the above phenomena of friction and mechanical compression, that is to say uncontrollable effects that are built up as a consequence of the compression of the laminate ahead of the ultrasonic device and energy losses as a consequence of the mechanical compression of the material. This deviation from the anticipated linear relationship can occur when the process speed exceeds a certain limit, which in this case depends on the constituent materials, their dimensioning and other parameters.

Against the background of the foregoing, it is possible to establish that a need exists for devices and methods for ultrasonic treatment offering favourable prospects of predictable and controllable process control. More optimal ultrasonic processing is provided in this way, which can be performed essentially regardless of the process speed.

Previously disclosed in patent document EP 84903 is the use of an ultrasonic device and a separate compression device. In this way, a material laminate can be processed with ultrasonic processing on the one hand, and can be compressed on the other hand. The compression of the material that is performed, however, takes place after the ultrasonic processing for the purpose of reinforcing the lamination of the material laminate concerned.

### OBJECTS AND SUMMARY

One principal object of the present disclosure is thus to make available an arrangement and a method for processing of a material or a material combination by an ultrasonic device.

The above object is achieved with an arrangement of the kind referred to by way of introduction, which includes a pre-compression unit for the mechanical compression of the aforementioned material before it is fed through the aforementioned gap.

The object is also achieved with a method of the kind referred to by way of introduction, which also includes mechanical pre-compression of the material before it is fed through the aforementioned gap.

Certain significant advantages are achieved, Firstly, it can be noted that the above-mentioned undesired effects in the form of friction and mechanical compression of the material at the ultrasound horn can be minimized, which gives an increased process window and a more stable process for processing with the ultrasonic device. This is particularly noticeable at high speeds.

The ability to optimize the ultrasound process in a better way than previously also enables lower wear to be achieved in the ultrasonic device and its associated equipment by means of the invention. A further advantage is that it leads to lower shearing forces on the material that is fed past the ultrasonic device.

### BRIEF DESCRIPTION OF DRAWINGS

The invention is described below in conjunction with preferred illustrative embodiments and the accompanying drawings, in which

FIG. 1 is a schematic side view of an ultrasonic device according to an embodiment of the present invention;

FIG. 2 is an enlarged side view which shows certain parts of the arrangement according to FIG. 1;

FIG. 3 is a view from above, which shows a pattern that is produced with an arrangement according to an embodiment of the invention; and

FIG. 4 is a schematic side view of an ultrasonic device according to an alternative embodiment the invention.

### DETAILED DESCRIPTION OF THE PREFERRED EMBODIMENTS

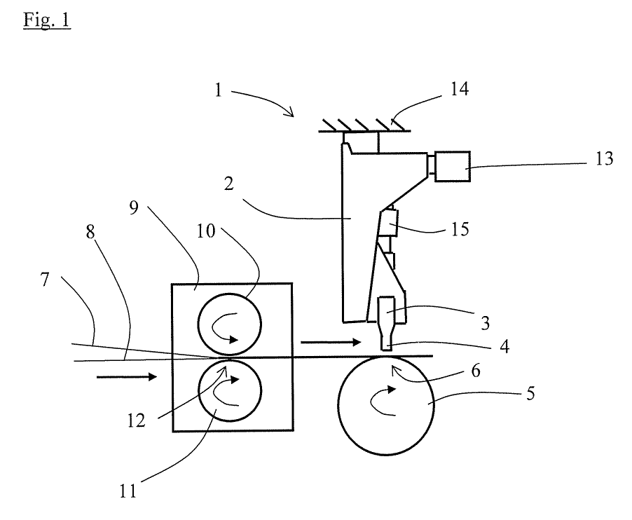

FIG. 1 is a schematic side view of an arrangement 1 for ultrasound processing, which is intended for use in conjunction with the present invention. More specifically, in accordance with the prior art, the arrangement 1 comprises an ultrasonic device 2 with an ultrasound horn 3, which in turn is executed with a contact device 4, that is to say an end part.

It can also be appreciated from FIG. 1 that the ultrasonic device 2 is arranged in close proximity to a rotating abutment roller 5, the periphery of which defines an abutment surface. The abutment roller 5 is also appropriately provided with patterns intended to contribute to the ultrasound processing in question. The contact device 4 of the ultrasound horn 3 also faces towards the material and is arranged with a small distance to the periphery of the abutment roller 5. A small gap 6 is formed in this way, that is to say a relatively small distance between the contact device 4 and the peripheral surface of the abutment roller 5. A laminate which consists of two layers of material 7, 8, more particularly an upper material layer 7 and a lower material layer 8, is fed through this gap 6. These material layers 7, 8 consist of continuous webs of material that are fed from (not illustrated) rollers, from a folded material or the like and onwards through the gap 6 in order to be joined together to form a laminate.

The ultrasonic device 2 is arranged for processing by ultrasound technology, for example in the form of welding, cutting, perforation, embossing or some other type of ultrasound processing. In the embodiment described below, processing of the ultrasonic welding type is used, that is to say joining together of two or more layers of material. The disclosure is not, however, restricted to use for ultrasonic welding alone, but can also be utilized in alternative ways, for example with one or other of the above-mentioned types of processing. The disclosure can also be combined with other processes, for example the printing of colours on the various constituent materials 7, 8.

The disclosure is particularly suitable for use in those applications in which the material webs 7, 8 consist of nonwoven material, that is to say fibrous materials with fibres such as polyolefins, that is to say polymer materials such as polyethylene and polypropylene, or alternatively materials made of polyester, nylon or the like. Mixtures of different types of fibres can also be used for the material webs 7, 8. Such materials are used among other things in the manufacture of absorbent products, for example in the form of diapers, incontinence pads, sanitary towels and panty liners.

The disclosure is not restricted to use in conjunction with processing of nonwoven materials alone, but can also be applied in conjunction with the processing of other materials, for example films of thermoplastics, for example polyethylene or polypropylene. The material webs 7, 8 can also be in the form of materials made from natural fibres (for example wood or cotton fibres), foam material or other materials that are capable of being welded using ultrasound technology.

The disclosure is also suitable for materials which consists of only a single layer of material that are to be subjected to some form of ultrasound processing, for example pattern embossing. Similarly, the invention can be utilized for processing of materials which consist of two or more layers, for example for the joining together of such materials by means of ultrasonic welding in accordance with what is described in conjunction with the embodiment in accordance with FIG. 1.

The disclosure is not restricted to materials in the form of essentially continuous webs of material alone, but can also be used alternatively in those cases in which the material consists of discrete items that are fed past an ultrasonic device, that is to say individual, cut pieces of material that are fed through the gap in the ultrasonic device.

An important underlying principle of the disclosure is that the arrangement 1 includes a pre-compression unit 9, which is so arranged as to compress the constituent materials 7, 8 before they are fed onwards towards the ultrasonic device 2. More particularly, the pre-compression unit 9 includes a first rotating roller 10 and a second rotating roller 11. These rollers 10, 11 are so arranged that the webs 7, 8 of material are fed through a small gap 12 that is defined between the peripheral surfaces 10, 11 of the rollers. In a way that will be described in greater detail below, the purpose of this is to “pre-compress” the webs 8, 9 of material by mechanical means before they are fed past the ultrasonic device 2. A more gentle process is obtained through such pre-compression, with the help of which the influence of the effects mentioned by way of introduction, such as the friction and the mechanical compression of the materials 7, 8 that are caused, can be minimized as they move past the gap 6 at the contact device 4 of the ultrasound horn 3. This means that the “process window”, that is to say the interval relating to process parameters which control the ultrasound processing, can be made broader compared with the prior art. This in turn permits a stable, predictable and controllable process for the ultrasound processing, which is particularly noticeable at relatively high process speeds.

The disclosure is particularly suitable for relatively thick materials, more particularly materials which have a weight that exceeds 30 g/m². It can be established, however, that the material thickness at which the disclosure has its greatest effect also depends on the process speed, among other things. The disclosure can also be used for relatively thin materials, or alternatively for a thin material in combination with a thick material. Examples of materials that are suitable are elastic laminates, with a weight that is normally ca. 40-80 g/m², relatively tight nonwoven materials (>30 g/m²) and tissue materials.

One or both of the pre-compression rollers 10, 11 can be provided with some suitable form of pattern, which can then be used, for example, for embossing the constituent materials 10, 11. The embossing which is then provided by the pre-compression unit 9 can then be caused to supplement the subsequent ultrasound processing in an appropriate manner. This is described in greater detail below.

In a manufacturing process, the ultrasonic device 2 is operated so that the contact device 4 of the ultrasound horn 3 is pushed down over the pre-compressed material layers 7, 8 while these are being fed forwards, in accordance with what is illustrated schematically with arrows (to the right) in FIG. 1. In conjunction with this, the ultrasonic device 2 is operated at a certain given frequency and power, which leads to the two layers 7, 8 of material being welded together. The layers 7, 8 of material have thus been passed through the gap 12 in the pre-compression unit 9 beforehand, which results in a gentle ultrasound process associated with a minimization of friction and mechanical compression at the precise point of passing the contact device 4.

In accordance with the prior art, the arrangement 1 in accordance with the invention is arranged for the regulation of the size of the gap 6. The purpose in this case is to ensure that a certain given and essentially constant energy is supplied to the material layers 7, 8 in order to achieve the intended ultrasound processing. For this purpose, the ultrasonic device 2 is so arranged as to be capable of movement in such a way that the position of the contact device 4 of the ultrasound horn 3 can be varied in relation to the abutment roller 5. With further reference to FIG. 1, it can be appreciated that the arrangement 1 comprises a drive unit 13, which can consist of an electric motor or alternatively of a hydraulic drive arrangement. The drive unit 13 is used for adjustment of the position of the ultrasound horn 3 in relation to the abutment roller 5. This is achieved appropriately by a displacement of the entire ultrasonic device 2 in relation to the drive unit 13, which in turn is rigidly mounted in a fixture 14 or similar, in accordance with what is illustrated schematically in FIG. 1. The drive unit 10 is also attached to the ultrasonic device 2 via a power transmission 15. The drive unit 10 is also connected electrically to a control unit (not shown), which is appropriately computer-based and so arranged as to control the drive unit 13 in accordance with certain input signals, for example an indication of the force acting against the layers 7, 8 of material and the abutment roller 5 when the ultrasound horn 3 is applied to the layers 7, 8 of material. An indication of this kind can be provided by a (not illustrated) load cell, which is a previously disclosed type of sensor that is based on the principle of converting a mechanical force into an electrical output signal. As an alternative to a load cell, the disclosure can also be implemented with sensors, for example of the strain gauge or piezoelectric element type. The load cell can be electrically connected to the aforementioned control unit, which is so arranged in this case, depending on the signal relating to the measured force, as to adjust the ultrasonic device 2 to an appropriate position in the vertical sense in relation to the abutment roller 5. The size of the gap 6 can be regulated in this way.

The rollers 10, 11 that are included in the pre-compression unit 9 also comprise a gap 12, the size of which can be regulated. This is in itself previously disclosed and is not illustrated here in detail for that reason.

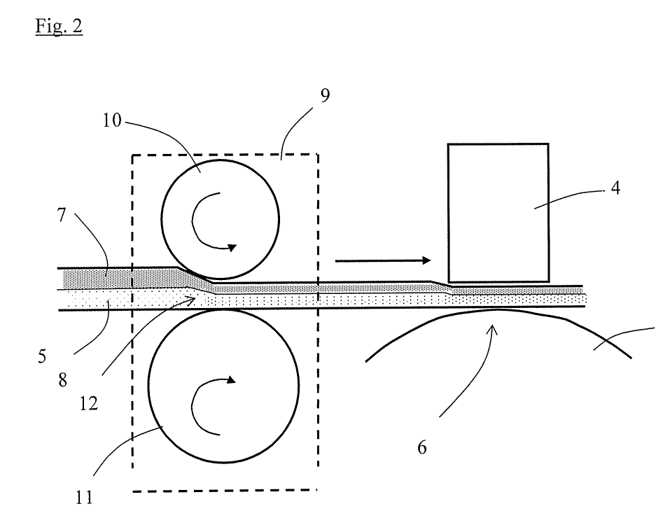

FIG. 2 is a somewhat enlarged side view which illustrates the principles of the disclosure. More particularly, FIG. 2 illustrates in detail how the two constituent materials 7, 8 are first compressed by the two rollers 10, 11 and are then fed through the gap 6 that is defined between the contact device 4 of the ultrasonic device 2 and the abutment roller 5. The materials 7, 8 are fed in the direction indicated by an arrow in FIG. 2. It can be noted that the materials 7, 8 initially have a certain combined thickness before they are fed through the gap 12 between the rollers 10, 11. This combined thickness will be reduced somewhat by the pre-compression provided by the rollers 10, 11. This means that the materials 7, 8 will be fed past the gap 6 in the contact device 4 of the ultrasonic device while a reduction in friction and mechanical compression is achieved at the gap 6, compared with the prior art as described above. When the materials 7, 8 pass through the gap 6, their thickness is further reduced somewhat and is influenced by the ultrasound processing. All in all, the advantages relating to a more optimized process for the ultrasound process in accordance with what has been explained above are achieved with the disclosure.

The disclosure is appropriately intended to be arranged in such a way that the pre-compression unit 9 provides pre-compression to an extent such that the materials 7, 8 to all intents and purposes become permanently deformed after passing through the rollers 10, 11 of the pre-compression unit 9. Pre-compression then takes place preferably to such a degree that the fibres in the materials 10, 11 are joined together in a mechanical manner. The degree of compression is appropriately selected so that a certain, smaller degree of resilience of the materials 7, 8 is obtained after they have been compressed by the rollers 10, 11.

In order to achieve a desired degree of pre-compression, the pre-compression unit 9 should be situated in close proximity to the contact device 4 of the ultrasonic device 2. This is desirable not least in view of the wish to match a pattern that may be provided in the pre-compression unit 9 to a subsequent welded pattern in the ultrasonic device 2. The wish may exist, for example, for the pre-compression unit 9 and the ultrasonic device 2 to process the materials concerned with exactly the same pattern. This matching of the patterns is facilitated if the pre-compression unit 9 is situated very close to the contact device 4 of the ultrasonic device 2. In accordance with one appropriate design, the pre-compression unit 9 can be positioned 0-3 metres in front of the ultrasonic device 2, although the invention is not restricted to any specific distance between these two units. The distance can vary, therefore, depending primarily on the pattern that is to be applied to the materials concerned.

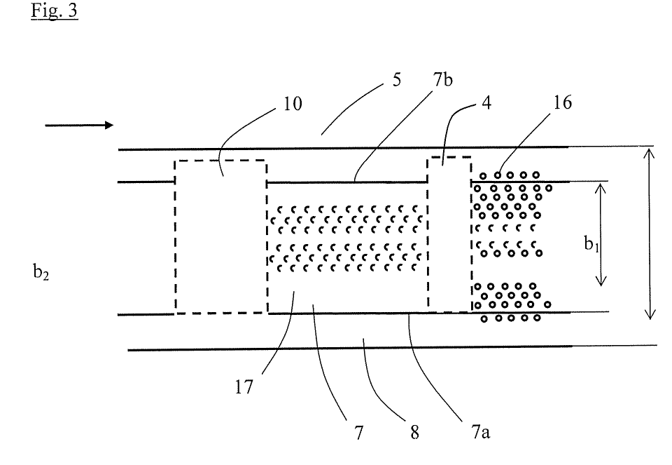

FIG. 3 is a view in principle from above viewed in the direction downwards towards the two layers 7, 8 of material, where the positions of the first roller 10 and the contact device 4 of the ultrasound horn 3 are also indicated schematically with broken lines. The direction of feed of the materials 7, 8 is indicated by an arrow in FIG. 3. It can be appreciated from FIG. 3 that the upper material layer 7 possesses a width b₁ that is smaller than the width b₂ of the lower material layer 8. These material layers 7, 8 are also intended to be welded together along the respective lateral edge 7a, 7b of the upper material layer 7 and, in addition, to be pattern-embossed within a specific area between these lateral edges 7a, 7b. This is indicated in FIG. 3 with a welded pattern 16 that has been executed on the material layers 7, 8 along a section of the material layers 7, 8 which have just been fed past the contact device 4, that is to say which are positioned to the right of the contact device 4 and which have thus been laminated together. This welded pattern 16 is shown in FIG. 3 as small circles. The welded pattern 9 is selected in a previously disclosed manner through a suitable corresponding design of the abutment roller 5. The pattern embossing is illustrated in FIG. 3 in the form of a further embossed pattern 17, which is illustrated in the form of c-like symbols, and which, in accordance with the embodiment, is provided by the first roller 10. This embossed pattern 17 thus supplements the welded pattern 16.

The pre-compression unit 9 compresses the materials 7, 8 to an extent such that the compression pattern 17 partially overlaps the subsequent welding pattern 16 that is provided by the ultrasonic device 2. Another example—which cannot be appreciated from FIG. 3—is that the compression pattern 17 that is provided by the pre-compression unit 9 and the pattern 16 that is provided by the ultrasonic device 2 are the same and overlap one another, or that the pre-compression pattern 17 consists of quite large points or the like, which are overlapped by the ultrasound pattern 16.

The pre-compression unit 9 can also be arranged as a so-called thermo bonding unit, that is to say in which the rollers are heated up to a high temperature in order to bring about bonding together of the constituent materials.

It must also be noted that the disclosure is not restricted to continuous patterns, as shown in FIG. 3, but can also be applied in those cases in which intermittent patterns are utilized.

It must be noted here that the disclosure can be applied to different configurations of layers of material. It should accordingly be pointed out that the disclosure is not restricted solely to the configuration illustrated in FIG. 2 with two layers 7, 8 of material, in which the second layer 8 of material is broader than the first layer 7 of material, and in which the latter is positioned on top of the second layer 8 of material so that it ends up inside its lateral edges. The disclosure is also not restricted to any particular welded pattern or embossed pattern. As a consequence of the fact that the width b₁ of the upper layer 7 of material can vary somewhat in the longitudinal direction, the contact device 4 of the ultrasound horn must also be somewhat broader than the width b₁ of the upper layer 7 of material. The patterns 16, 17 that are illustrated in FIG. 2 are only examples of how such patterns can be executed, and many other variants are possible within the scope of the invention, for example depending on the type of processing that is required and the characteristics that are desired in the finished product.

In accordance with the embodiment, the welding process can be executed if the two layers 7, 8 of material are arranged as shown in FIG. 3, that is to say directly above one another, in conjunction with which one of the layers 7 of material is narrower than the other layer 8 of material. Alternatively, the layers 7, 8 of material can partially overlap one another, that is to say one layer of material can be displaced in a direction across the direction of feed in relation to the second layer of material. In accordance with a further alternative, both layers of material can have the same width. They can be positioned directly on top of one another in this case, or alternatively in an overlapping manner.

The patterns 16, 17 that are selected can be executed in accordance with the prior art based on a number of factors, such as the desired performance of the finished product, the desired visual appearance of the finished product, and with the intention of permitting efficient manufacture (that is to say depending on process engineering requirements and wishes). It is appropriate, for example, for the different constituent layers 7, 8 of material to be narrower than the pattern that is to be provided, in accordance with what is illustrated in FIG. 3. The patterns 16, 17 that are shown in FIG. 3 are thus only examples of how one such pattern may be executed.

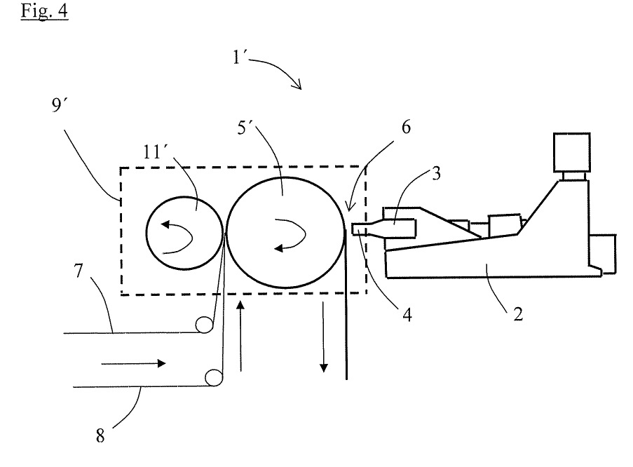

Illustrated in FIG. 4 is a schematic side view of an arrangement 1′ in accordance with an alternative embodiment of the invention. The components that are included in the embodiment in accordance with FIG. 4, and that are also encountered in the embodiment in accordance with FIG. 1, are identified with the same reference designations. In accordance with what is illustrated in FIG. 4, mechanical pre-compression and ultrasonic welding are provided with the help of a first roller 5′, which on the one hand constitutes an abutment roller for the ultrasonic device 2, and on the other hand is included in a pre-compression unit 9′, and a further roller 11′. In other words, two rollers in total are used, that is to say the combined abutment and pre-compression roller 5′ and a further roller 11′, which is then also utilized in the pre-compression process. In other respects, the embodiment in accordance with FIG. 4 is arranged in the same way as the embodiment in accordance with FIG. 1 and provides a certain degree of pre-compression in the pre-compression unit 9′, which in turn leads to the advantages in respect of a more optimal ultrasound process, as explained above.

The invention is not restricted to what is indicated above, but different embodiments are possible within the context of the patent Claims. For example, the disclosure is not restricted solely to welding, but can be used for other types of processing by means of ultrasound technology. The disclosure can also be utilized for different types of material, for example non-woven material or other types of synthetic or textile material. The disclosure can be used for different types of laminate with a varying number of constituent layers of material.

It must be pointed out that the disclosure can be executed alternatively in such a way that the abutment roller 5, 5′ is so arranged as to be capable of displacement, instead of the ultrasonic device 2. In accordance with a further variant, both the abutment roller 5, 5′ and the ultrasonic device 2 can be so arranged as to be capable of displacement with a view to permitting regulation of the size of the gap 6.

Other types of abutment surface can also be utilized as an alternative to the above-mentioned abutment roller 5, 5′. For example, the abutment surface can be defined by a plane surface which functions as an abutment.

In accordance with a further variant of the disclosure, the ultrasound horn can be of the rotating type. One example of such an application is an ultrasound horn that is caused to rotate at the same speed as an abutment roller, that is to say when no friction arises in the same way as in the rigidly mounted ultrasound horn 3 described above. An addition to the compression force is obtained by means of a pre-compression unit that it utilized as a supplement to a rotating ultrasound horn, so that the ultrasound energy from the rotating ultrasound horn can be utilized in a more optimal fashion. In accordance with a further alternative, this can be utilized in such a way that a non-rotating ultrasonic device is displaced along with it or with the webs of material that are intended to be processed, that is to say in its longitudinal direction.

1. An arrangement for processing of a material comprising at least one layer of material by an ultrasonic device, the arrangement comprising:
an ultrasound horn arranged adjacent to an abutment;
a gap is defined between the ultrasound horn and the abutment;
the ultrasonic device is arranged for the purpose of feeding the material through the gap; and
a pre-compression unit for the mechanical compression of the material before it is fed through the gap;
wherein the pre-compression unit comprises two pre-compression rollers at least one of which is provided with a pattern for embossing said material.

2. The arrangement according to claim 1, wherein the ultrasound horn is arranged in a stationary manner, in conjunction with which the material is fed through the gap.

3. The arrangement according to claim 1, wherein the ultrasonic device is arranged for processing of material of the nonwoven layer type, thermoplastic films, fibre material, or foam material intended for absorbent products.

4. The arrangement according to claim 1, wherein the two pre-compression rollers define a gap through which the material is fed during processing.

5. The arrangement according to claim 1, wherein the materials include two or more layers of material.

6. The arrangement according to claim 1, wherein the ultrasound horn and/or the abutment are so arranged as to be capable of displacement for adjustment of the size of the gap.

7. The arrangement according to claim 1, wherein the abutment consists of a rotating abutment roller.

8. The arrangement according to claim 1, wherein the ultrasonic device is arranged for processing in the form of ultrasonic welding of at least two layers of material to produce a laminate.

9. A method for processing of a material comprising at least one layer of material by an ultrasonic device comprising an ultrasound horn arranged adjacent to an abutment, in conjunction with which the method comprises feeding the material through a gap that is defined betweeen the ultrasound horn and the abutment, wherein the method also includes a mechanical pre-compression of the material before it is fed through the gap, and embossing said material by the pre-compression unit which is provided with two pre-compression rollers, at least one of which is provided with a pattern for said embossing.

10. The method according to claim 9, wherein the ultrasound horn is maintained stationary in relation to the material in conjunction with the feeding of the latter through the gap.

11. The method according to claim 9, wherein the method involves processing of material of nonwoven layer type, thermoplastic films, fibre material, or foam material intended for absorbent products.

12. The method according to claim 9, wherein the method involves feeding the material through a gap that is defined between the two pre-compression rollers, with the help of which the pre-compression is provided.

13. The method according to claim 9, wherein the ultrasound horn or the abutment are movably arranged to permit adjustment of the size of the gap.

14. The method according to claim 9, wherein the ultrasound horn and the abutment are movably arranged to permit adjustment of the size of the gap.
